(19) United States
(12) Patent Application Publication
(10) Pub. No.: US 2005/0031403 A1
(43) Pub. Date: Feb. 10, 2005

(54) Dry-erase marker support systems

(76) Inventors: Mark Pohmajevich, Scottsdale, AZ (US); Debra D. O'Neil, Mesa, AZ (US)

Correspondence Address: STONEMAN LAW OFFICES, LTD, 3113 NORTH 3RD STREET, PHOENIX, AZ, 85012, US

(21) Appl. No.: 10/913,734

(22) Filed: Aug. 5, 2004

Related U.S. Application Data
(60) Provisional application No. 60/493,131, filed on Aug. 6, 2003.

(51) Int. Cl. B43K 23/02

(52) U.S. Cl. 401/131

(57) ABSTRACT

A dry-erase marker support system relating to providing a dry-erase marker and dry-erase-marker-holder, attachable to a mirror, for use in writing dry-erasable messages onto a non-porous vertical mirror surface. Preferably, the system comprises a themed decorative method and support base that attaches by suction cup to the mirror and fixably retains the dry-erase marker cap so that only the dry-erase marker needs removal from the cap to be ready for use.

### CROSS-REFERENCE TO RELATED APPLICATION

The present application is related to and claims priority from prior provisional application Ser. No. 60/493,131, filed Aug. 06, 2003, entitled “SURFACE-ATTACHABLE MARKING ASSEMBLY”, the content of which is incorporated herein by this reference and is not admitted to be prior art with respect to the present invention by the mention in this cross-reference section.

### BACKGROUND

This invention relates to providing a dry-erase marker support system relating to providing an easily attachable mirror writing instrument and writing instrument holder.

Typically, people communicate in many ways. One of the ways people communicate is writing. Written messages require a writing tool and a media upon which the writing is done. Easily locating a writing tool and a media at the same moment can be a daunting task, especially around a home environment where items are often misplaced or not returned to the desired location. A need exists to provide an easy access and replacement for both a writing instrument and a writing media.

Even more importantly, messages must be placed where the message recipient will see the message. Many attempts have been made in the prior art to locate messages where they will be easily seen, along with a wide variety of writing tools, and media for leaving messages. There is a constant need to find a better place for messages to be placed for reading by the intended recipient.

One place people frequent often and are likely to look at, are places with a mirror. Attempts have been made to leave messages on a mirror using sticky paper notes, lipstick and soap, however such messages are not easily removed and such writing tools are not easily available where the mirror may be located. It would be very useful to locate a writing instrument near a mirror that is easily available and contains a writing media that is easily removed from the mirror.

Even further, many non-porous vertical surfaces exist, such as ceramic tile, glass, etc. that are located near phones, computers, bathrooms, etc. where people frequent and may read a message left for them; or utilize an easily erasable writing tool to leave a message.

Still further, many businesses offer items for sale, for example, to promote their business, for a souvenir, to promote a holiday theme, for memorabilia, etc. A need exists for such businesses to display and sell such items as well as advertise their products and services. Moreover, many people collect such souvenirs, holiday themed items and memorabilia. It would be very useful to combine the above-stated business use and personal collecting use with a writing tool.

### OBJECTS AND FEATURES OF THE INVENTION

A primary object and feature of the present invention is to solve the above-mentioned problems and meet the above-mentioned needs.

Another primary object and feature of the present invention is to provide a system for supporting a writing tool for writing on a mirror.

It is a further object and feature of the present invention to provide such a system that provides a writing media that is easily removed from a writing media.

It is a further object and feature of the present invention to provide such a system that provides a system for supporting a writing tool for writing on a non-porous surface.

It is a further object and feature of the present invention to provide such a system that provides a combined themed use with a writing tool.

It is a further object and feature of the present invention to provide such a system that provides a business method and use for producing, marketing and selling advertising and promotional items for increasing sales utilizing themed decorative bases and writing tools in combination with advertising indicia placed on the themed decorative bases and writing tools.

It is a further object and feature of the present invention to provide such a system that provides a business method and use for producing, marketing and selling themed souvenirs in combination with themed decorative bases and writing tools.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a dry-erase marker support system, comprising: dry-erase marker means for marking dry-erasable indicia on at least one non-porous essentially vertical surface; holder means for removably holding such dry-erase marker means; decorative support means for decoratively supporting such holder means; and attacher means for removably and non-destructively attaching such decorative support means to the at least one non-porous essentially vertical surface. Moreover, it provides such a dry-erase marker support system wherein such attacher means comprises suction means for assisting suction attachment of such decorative support means to the at least one essentially non-porous vertical surface. Additionally, it provides such a dry-erase marker support system wherein such suction means further comprises suction stabilizer means for assisting stabilizing of such suction means when such decorative support means is pulled in at least one direction substantially parallel to the at least one non-porous essentially vertical surface.

In accordance with another preferred embodiment hereof, this invention provides a dry-erase marker support system, comprising: at least one dry-erase marker adapted to mark dry-erasable indicia on at least one non-porous essentially vertical surface; at least one holder adapted to removably hold such at least one dry-erase marker; at least one decorative support adapted to decoratively support such at least one holder; and at least one attacher adapted to removably and non-destructively attach such at least one decorative support to the at least one non-porous essentially vertical surface. Also, it provides such a dry-erase marker support system wherein such at least one attacher comprises at least one suction cup to assist suction attachment of such at least one decorative support to the at least one non-porous essentially vertical surface. In addition, it provides such a dry-erase marker support system wherein such at least one suction cup further comprises at least one suction cup stabilizer adapted to assist stabilizing of such at least one suction cup when such decorative support is pulled in at least one direction substantially parallel to the at least one non-porous essentially vertical surface. And, it provides such a dry-erase marker support system wherein such at least one holder further comprises at least one receiver structured and arranged to receive such at least one dry-erase marker.

Further, it provides such a dry-erase marker support system wherein such at least one dry-erase marker comprises: at least one cap, having at least one exterior cap portion and at least one interior cap portion; wherein such at least one interior cap portion is adapted to cap such at least one dry-erase marker; and wherein such at least one exterior cap portion is removably coupled to such at least one dry-erase marker. Even further, it provides such a dry-erase marker support system wherein such at least one holder further comprises at least one receiver structured and arranged to receive such at least one exterior cap portion. Moreover, it provides such a dry-erase marker support system wherein such at least one receiver comprises at least one recess in such at least one decorative support structured and arranged to receive the at least one exterior cap portion. Additionally, it provides such a dry-erase marker support system wherein such at least one exterior cap portion of such at least one cap is permanently held in such at least one receiver.

Also, it provides such a dry-erase marker support system wherein such at least one suction cup comprises: at least one forward side and at least one rearward side, adapted to removably attach to at least one non-porous essentially vertical surface; wherein such at least one forward side comprises at least one flexible vacuum producer; and wherein such at least one rearward side comprises at least one projection. In addition, it provides such a dry-erase marker support system wherein: such at least one projection comprises at least one collar supporting at least one portion of the periphery of the projection; wherein such at least one collar comprises such at least one suction cup stabilizer. And, it provides such a dry-erase marker support system wherein: such at least one receiver comprises at least one recess in such at least one decorative support structured and arranged to receive such at least one projection; and such at least one projection, when coupled within such at least one recess comprises such at least one suction cup stabilizer. Further, it provides such a dry-erase marker support system wherein such at least one suction cup is mechanically attached to such at least one decorative support.

Even further, it provides such a dry-erase marker support system wherein such at least one suction cup is adhesively attached to such at least one decorative support. Moreover, it provides such a dry-erase marker support system wherein such at least one decorative support comprises at least one decorative theme element to provide a decorative theme to such at least one decorative support. Additionally, it provides such a dry-erase marker support system wherein such at least one decorative theme element comprises at least one sport theme. Also, it provides such a dry-erase marker support system wherein such at least one decorative theme element comprises at least one Holiday theme. In addition, it provides such a dry-erase marker support system wherein such at least one decorative theme element comprises at least one souvenir theme. And, it provides such a dry-erase marker support system wherein such at least one decorative theme element comprises at least one cartoon theme.

Further, it provides such a dry-erase marker support system wherein such at least one decorative theme element comprises at least one clock theme. Even further, it provides such a dry-erase marker support system wherein such at least one decorative theme element comprises at least one picture frame theme. Moreover, it provides such a dry-erase marker support system wherein such at least one decorative theme element comprises at least one custom indicia theme. Additionally, it provides such a dry-erase marker support system wherein such at least one dry-erase marker is adapted to write on at least one mirror surface. Also, it provides such a dry-erase marker support system wherein such at least one decorative support base comprises at least one first indicia. In addition, it provides such a dry-erase marker support system wherein such at least one dry-erase marker comprises at least one second indicia.

In accordance with another preferred embodiment hereof, this invention provides a dry-erase marker decorative support system, comprising: at least one dry-erase marker adapted to mark dry-erasable indicia on at least one non-porous essentially vertical surface; at least one holder adapted to removably hold such at least one dry-erase marker; at least one decorative support adapted to decoratively support such at least one holder; and at least one attacher adapted to removably and non-destructively attach such at least one decorative support to the at least one non-porous essentially vertical surface; wherein such at least one decorative support comprises at least one suction cup adapted to assist suction attachment of such at least one decorative support to the at least one non-porous essentially vertical surface; wherein such at least one holder further comprises at least one receiver structured and arranged to receive at least one portion of such at least one suction cup; wherein such at least one receiver comprises at least one recess in such at least one decorative support structured and arranged to recess the at least one portion of such at least one suction cup; wherein the at least one portion of such at least one suction cup, when coupled within such at least one recess, assist stabilizing of such at least one suction cup to such at least one decorative support when such at least one decorative support is pulled in at least one direction substantially parallel to the at least one non-porous essentially vertical surface; wherein such at least one dry-erase marker further comprises at least one cap, having at least one exterior cap portion and at least one interior cap portion, wherein such at least one interior cap portion is adapted to cap such at least one dry-erase marker, and wherein such at least one exterior cap portion is removably coupled to such at least one dry-erase marker at least one cap, having at least one cap portion, adapted to cap such at least one dry-erase marker; wherein such at least one cap is removably couplable to such at least one dry-erase marker; wherein such at least one holder further comprises at least one receiver structured and arranged to receive such at least one exterior portion of such at least one cap; wherein such at least one receiver comprises at least one recess in such at least one decorative support structured and arranged to recess such at least one exterior portion of such at least one cap; wherein the at least one exterior portion of such at least one cap is permanently held in such at least one recess; wherein such at least one dry-erase marker is removably coupled to such at least one cap; wherein such at least one decorative support base may be removably attached to the at least one non-porous essentially vertical surface by such at least one suction cup; and wherein such at least one dry-erase marker may be removed from such at least one interior cap portion to write on the at least one non-porous essentially vertical surface. And, it provides such a dry-erase marker support system wherein such at least one decorative support comprises at least one decorative theme element to provide a decorative theme to such at least one decorative support base. Further, it provides such a dry-erase marker support system wherein such at least one dry-erase marker is adapted to write on at least one mirror surface.

In accordance with another preferred embodiment hereof, this invention provides a dry-erase marker support kit system, comprising: at least one first dry-erase marker adapted to mark dry-erasable indicia on at least one non-porous essentially vertical surface; at least one holder adapted to removably hold such at least one dry-erase marker; at least one decorative support adapted to decoratively support such at least one holder; at least one attacher adapted to removably and non-destructively attach such at least one decorative support to the at least one non-porous essentially vertical surface; and at least one first kit container adapted to contain such at least one dry-erase marker, such at least one holder and such at least one attacher. Even further, it provides such a dry-erase marker support kit system wherein such at least one container comprises at least one set of instructions. Moreover, it provides such a dry-erase marker support kit system wherein such at least one container comprises at least one transparent portion adapted to assist viewing of the dry-erase marker support kit system while contained by such at least one container.

Additionally, it provides such a dry-erase marker support kit system further comprising at least one second kit container adapted to contain such at least one second dry-erase marker. Also, it provides such a dry-erase marker support kit system further comprising: at least one display fixture structured and arranged to display a plurality of such at least one first kit containers; wherein such at least one display fixture comprises at least one mirror adapted to support at least one of such at least one decorative supports. In addition, it provides such a dry-erase marker support kit system wherein such at least one display fixture is structured and arranged to display a plurality of such at least one second kit containers.

In accordance with another preferred embodiment hereof, this invention provides a method of marketing a plurality of marker systems, comprising, in combination, the steps of: specifying at least one design for at least one marker system; wherein such at least one marker system comprises at least one dry-erase marker adapted to mark dry-erasable indicia on at least one non-porous essentially vertical surface, at least one holder adapted to removably hold such at least one dry-erase marker, at least one decorative support adapted to decoratively support such at least one holder, and at least one attacher adapted to removably and non-destructively attach such at least one decorative support to the at least one non-porous essentially vertical surface; securing at least one order from at least one advertiser, having at least one marketing indicia, for such at least one marker system; specifying at least one location, on such at least one marker system, for placement of such at least one marketing indicia; providing for delivery of such at least one marker system to at least one destination provided by such at least one advertiser; receiving from the at least one advertiser at least one payment for the at least one indicia-displaying marker system delivered to the at least one advertiser; and paying the at least one manufacturer for the shipped at least one indicia-displaying marker system.

And, it provides such a method further comprising the step of placing such at least one marketing indicia on such at least one decorative support. Further, it provides such a method further comprising the step placing such at least one marketing indicia on such at least one dry-erase marker. Even further, it provides such a method further comprising the step of placing such at least one marketing indicia on such at least one dry-erase marker. Moreover, it provides such a method further comprising the step of placing at least one supplier address, for ordering at least one dry-erase marker replacement kit, on such at least one decorative support.

Additionally, it provides such a method wherein such at least one supplier address comprises at least one Internet universal resource locator address. Also, it provides such a method further comprising the steps of: specifying components of such least one dry-erase marker replacement kit; wherein such components comprise at least one replacement dry-erase marker; placing at least one supplier indicia on each such at least one replacement dry-erase marker; securing at least one replacement order from at least one end user for such at least one dry-erase marker replacement kit; and providing for delivery of such at least one dry-erase marker replacement kit. In addition, it provides such a method wherein such step of securing at least one replacement order from at least one end user for such at least one dry-erase marker replacement kit comprises the steps of: permitting use of at least one Internet web site for creation of such at least one replacement order; and using such at least one Internet web site for receiving payment for such at least one replacement order. And, it provides such a method wherein such at least one decorative support comprises at least one sports-related representation. Further, it provides such a method further comprising the step of obtaining at least one license from at least one owner of such at least one sports-related representation. Even further, it provides such a method wherein such at least one marketing indicia comprises sports indicia. Moreover, it provides such a method further comprising the step of obtaining at least one license from at least one owner of such sports indicia.

Additionally, it provides such a method wherein such at least one owner of such sports indicia comprises at least one of the group consisting essentially of: sport governing associations; advertisers; manufacturers; teams; players; racers; and sport participants. Also, it provides such a method wherein such at least one decorative support comprises at least one cartoon-character-related representation. In addition, it provides such a method further comprising the step of obtaining at least one license from at least one owner of such at least one cartoon-character-related representation. And, it provides such a method wherein such at least one marketing indicia comprises cartoon-character-related indicia. Further, it provides such a method further comprising the step of obtaining at least one license from at least one owner of such cartoon-character-related indicia.

In accordance with another preferred embodiment hereof, this invention provides a method of marketing a plurality of souvenir marker systems, comprising, in combination, the steps of: specifying at least one design for at least one souvenir marker system; wherein such at least one souvenir marker system comprises at least one dry-erase marker adapted to mark dry-erasable indicia on at least one non-porous essentially vertical surface, at least one holder adapted to removably hold such at least one dry-erase marker, at least one decorative support adapted to decoratively support such at least one holder, and at least one attacher adapted to removably and non-destructively attach such at least one decorative support to the at least one non-porous essentially vertical surface; securing at least one order from at least one distributor for such at least one souvenir marker system; specifying at least one location, on such at least one souvenir marker system, for placement of such at least one souvenir indicia; providing for delivery of such at least one souvenir marker system to at least one destination provided by such at least one distributor; receiving from the at least one distributor at least one payment for the at least one indicia-displaying souvenir marker system delivered to the at least one advertiser; and paying the at least one manufacturer for the shipped at least one indicia-displaying souvenir marker system. Even further, it provides such a method further comprising the step of placing such at least one souvenir indicia on such at least one decorative support.

Even further, it provides such a method further comprising the step placing such at least one souvenir indicia on such at least one dry-erase marker. Even further, it provides such a method further comprising the step of placing such at least one souvenir indicia on such at least one dry-erase marker. Even further, it provides such a method further comprising the step of placing at least one supplier address, for ordering at least one dry-erase marker replacement kit, on such at least one decorative support. Even further, it provides such a method wherein such at least one supplier address comprises at least one Internet universal resource locator address. Even further, it provides such a method further comprising the steps of: specifying components of least one dry-erase marker replacement kit; wherein such components comprise at least one replacement dry-erase marker; placing at least one supplier indicia on each such at least one replacement dry-erase marker; securing at least one replacement order from at least one end user for at least one dry-erase marker replacement kit; and providing for delivery of at least one dry-erase marker replacement kit. Even further, it provides such a method wherein such step of securing at least one replacement order from at least one end user for such at least one dry-erase marker replacement kit comprises the steps of: permitting use of at least one Internet web site for creation of such at least one replacement order; and using such at least one Internet web site for receiving payment for such at least one replacement order. Even further, it provides such a method wherein such at least one decorative support comprises at least one souvenir-related representation. Even further, it provides such a method further comprising the step of obtaining at least one license from at least one owner of such at least one souvenir-related representation. Even further, it provides such a method wherein such at least one souvenir indicia comprises licensed souvenir indicia. Even further, it provides such a method further comprising the step of obtaining at least one license from at least one owner of such licensed souvenir indicia.

### BRIEF DESCRIPTION OF THE DRAWINGS

FIG. 1 shows a perspective view illustrating the dry-erase marker support system with a sport-ball themed embodiment according to a preferred embodiment of the present invention.

FIG. 2 shows a front view of the dry-erase marker support system of FIG. 1.

FIG. 3 shows a section view through section 3-3 of FIG. 2.

FIG. 4 shows an exploded view of the dry-erase marker support system of FIG. 1.

FIG. 5 shows a front view of another sport ball themed embodiment of the dry-erase marker support system.

FIG. 6 shows a front view of another sport ball themed embodiment of the dry-erase marker support system.

FIG. 7 shows a front view of a custom-printable-indicia-themed embodiment of the dry-erase marker support system according to a preferred embodiment of the present invention.

FIG. 8 shows a front view of a holiday themed embodiment of the dry-erase marker support system according to a preferred embodiment of the present invention.

FIG. 9 shows a front view of a “licensable” themed embodiment of the dry-erase marker support system according to a preferred embodiment of the present invention.

FIG. 10 shows a front view of a souvenir themed embodiment of the dry-erase marker support system according to a preferred embodiment of the present invention.

FIG. 11a shows a front view of a clock themed embodiment of the dry-erase marker support system according to a preferred embodiment of the present invention.

FIG. 11b shows a front view of a picture frame themed embodiment of the dry-erase marker support system according to a preferred embodiment of the present invention.

FIG. 12a shows a front perspective view of a kit system of the dry-erase marker support system according to a preferred embodiment of the present invention.

FIG. 12b shows a front perspective view of an accessory kit system of the dry-erase marker support system, comprising extra dry-erase markers, according to a preferred embodiment of the present invention.

FIG. 13 shows a front perspective view of a fixture display system of the dry-erase marker support system according to a preferred embodiment of the present invention.

FIG. 14 shows a diagrammatic view of a system and method for creating and selling at least one marker system according to a preferred embodiment of the present invention.

FIG. 15 shows a diagrammatic view of a system and method for Internet-based selling at least one marker system according to a preferred embodiment of the present invention.

### DETAILED DESCRIPTION OF THE BEST MODES AND PREFERRED EMBODIMENTS OF THE INVENTION

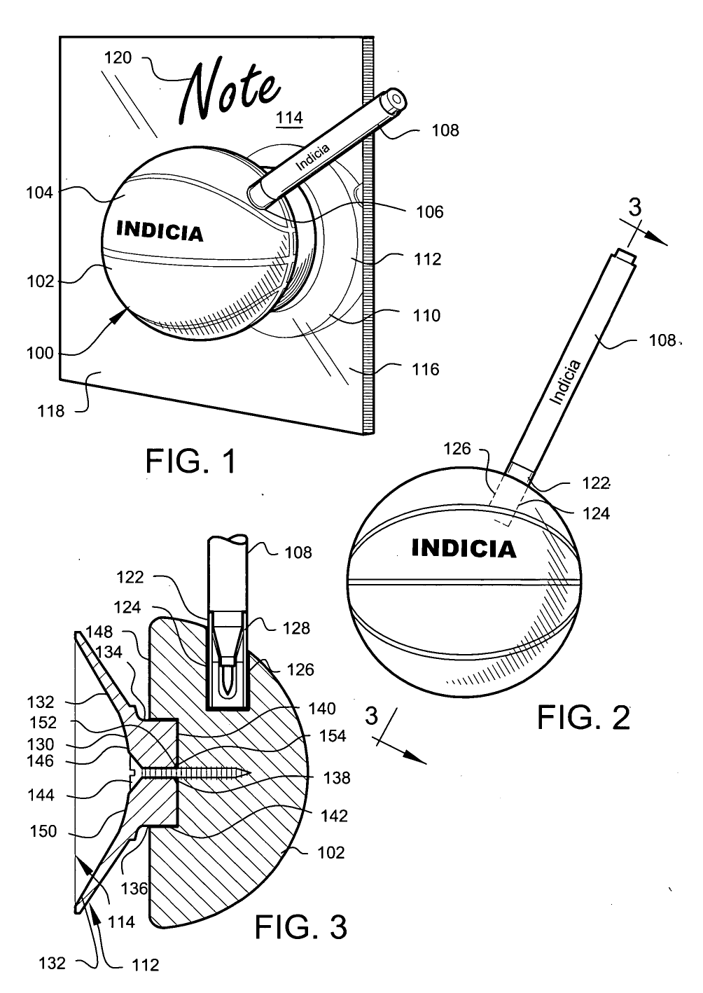

FIG. 1 shows a perspective view illustrating the dry-erase marker support system with a sport-ball themed embodiment according to a preferred embodiment of the present invention.

Preferably, the dry-erase marker support system comprises a support base 100, preferably a decorative support base 102, preferably comprising a themed decoration, for example, and basketball 104, as shown. Preferably, the decorative support base 102 comprises a holder 106, preferably for a dry-erase marker 108, as shown. Preferably, the decorative support base 102 comprises an attacher 110 (at least embodying herein attacher means for removably and non-destructively attaching such decorative support means to the at least one non-porous essentially vertical surface; and, at least embodying herein at least one attacher adapted to removably and non-destructively attach such at least one decorative support to the at least one non-porous essentially vertical surface), preferably a suction cup 112 that will adhere by suction to a preferably non-porous surface 114, preferably a vertical non-porous surface 118, preferably a mirror 116, as shown (this arrangement at least embodies herein wherein such attacher means comprises suction means for assisting suction attachment of such decorative support means to the at least one essentially non-porous vertical surface; and, at least embodies herein wherein such at least one attacher comprises at least one suction cup to assist suction attachment of such at least one decorative support to the at least one non-porous essentially vertical surface; and, embodying herein wherein such at least one marker system comprises at least one attacher adapted to removably and non-destructively attach such at least one decorative support to the at least one non-porous essentially vertical surface; and, embodying herein wherein such at least one souvenir marker system comprises at least one attacher adapted to removably and non-destructively attach such at least one decorative support to the at least one non-porous essentially vertical surface). Upon reading the teachings of this specification, those with ordinary skill in the art will now understand that, under appropriate circumstances, considering such issues as economic consideration, user preference, wall material, etc., other non-porous surfaces, such as ceramic tile, glass, laminate, etc., may suffice.

Preferably, decorative support base 102 (at least embodying herein decorative support means for decoratively supporting such holder means; and at least embodying herein at least one decorative support adapted to decoratively support such at least one holder; and, embodying herein wherein such at least one marker system comprises at least one decorative support adapted to decoratively support such at least one holder; and embodying herein wherein such at least one souvenir marker system comprises at least one decorative support adapted to decoratively support such at least one holder) is mounted on a mirror 116 such that dry-erase marker 108 (at least embodying herein dry-erase marker means for marking dry-erasable indicia on at least one non-porous essentially vertical surface; and, at least embodying herein at least one dry-erase marker adapted to mark dry-erasable indicia on at least one non-porous essentially vertical surface; and, embodying herein wherein such at least one marker system comprises at least one dry-erase marker adapted to mark dry-erasable indicia on at least one non-porous essentially vertical surface; and embodying herein wherein such at least one souvenir marker system comprises at least one dry-erase marker adapted to mark dry-erasable indicia on at least one non-porous essentially vertical surface) may be removed from holder 106 (embodying herein holder means for removably holding such dry-erase marker means; and, embodying herein at least one holder adapted to removably hold such at least one dry-erase marker; and, embodying herein wherein such at least one marker system comprises at least one holder adapted to removably hold such at least one dry-erase marker; and, wherein such at least one souvenir marker system comprises at least one holder adapted to removably hold such at least one dry-erase marker) and utilized to write on mirror 116, for example, writing note 120, as shown, Preferably, dry-erase marker 108 may be replaced into holder 106 for storage, as shown.

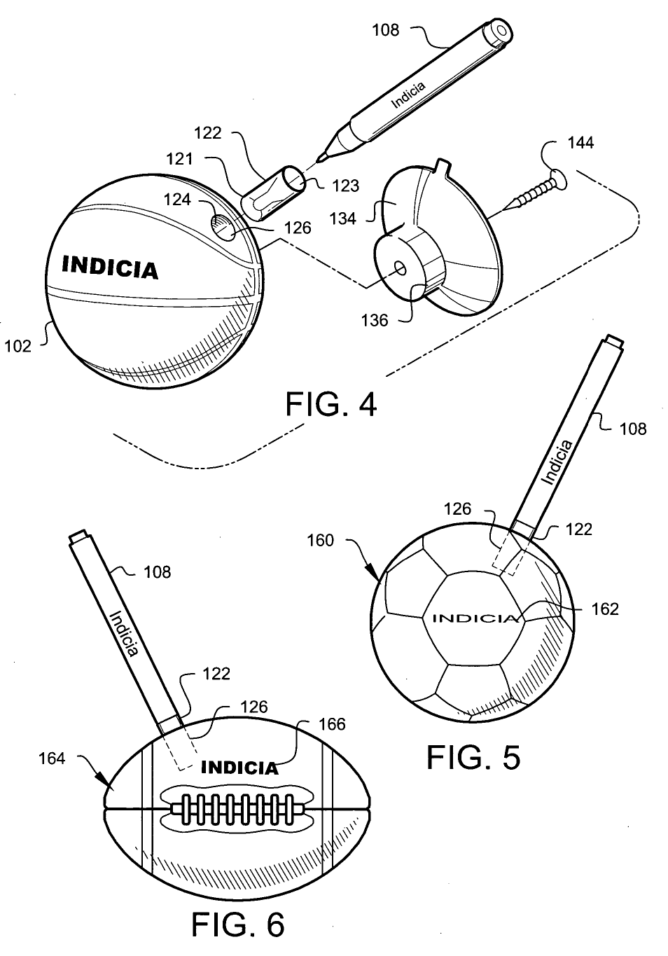

FIG. 2 shows a front view of the dry-erase marker support system of FIG. 1. FIG. 3 shows a section view through section 3-3 of FIG. 2. FIG. 4 shows an exploded view of the dry-erase marker decorative support system of FIG. 1. Preferably, dry-erase marker 108 comprises a cap 122, having an exterior portion 121 and an interior portion 123, as shown (at least embodying herein at least one cap, having at least one exterior cap portion and at least one interior cap portion). Preferably cap 122 is removably coupled to dry-erase marker 108 so that the interior portion 123 seals the dry-erase writing compound within dry-erase marker 108 so that they are preserved when cap 122 is coupled to dry-erase marker 108 (this arrangement at least embodies herein wherein such at least one interior cap portion is adapted to cap such at least one dry-erase marker; and, at least embodies herein wherein such at least one exterior cap portion is removably coupled to such at least one dry-erase marker). Preferably, holder 106 comprises at least one receiver 124 (at least embodying herein wherein such at least one holder further comprises at least one receiver structured and arranged to receive such at least one dry-erase marker), preferably a recessed bore 126, preferably sized to tightly encircle the perimeter 128 of cap 122, as shown (at least embodying herein wherein such at least one holder further comprises at least one receiver structured and arranged to receive such at least one exterior cap portion; and, at least embodying herein wherein such at least one receiver comprises at least one recess in such at least one decorative support structured and arranged to receive the at least one exterior cap portion). Preferably, cap 122 is placed into recessed bore 126 so that decorative support base 102, in combination with cap 122, supports dry-erase marker 108, as shown. Preferably, the exterior portion 121 of cap 122 is adhered into recessed bore 126 so that dry-erase marker 108 may be removed from cap 122 while cap 122 is attached to decorative support base 102, as shown (at least embodying herein wherein such at least one exterior cap portion of such at least one cap is permanently held in such at least one receiver).

Preferably, suction cup 112 comprises a forward side 130, having flexible vacuum producing elements 132, and a rearward side 134, having a mounting projection 136, as shown (at least embodying herein wherein such at least one suction cup comprises: at least one forward side and at least one rearward side, adapted to removably attach to at least one non-porous essentially vertical surface; wherein such at least one forward side comprises at least one flexible vacuum producer; and wherein such at least one rearward side comprises at least one projection). Preferably, decorative support base 102 comprises a recessed bore 140 (at least embodying herein such at least one receiver comprises at least one recess in such at least one decorative support structured and arranged to receive such at least one projection; and such at least one projection, when coupled within such at least one recess comprises such at least one suction cup stabilizer), preferably sized to tightly fit around the mounting projection 136 forming a stabilizing collar 142 around mounting projection 136 to assist in stabilizing mounting projection 136 and assisting in maintaining a suction seal when flexible vacuum producing element 132 is tightly placed against a non-porous surface 114, as shown (this arrangement at least embodies herein wherein such at least one projection comprises at least one collar supporting at least one portion of the periphery of the projection; wherein such at least one collar comprises such at least one suction cup stabilizer). Further, stabilizing collar 142 provides a stabilizing element that keeps the suction seal when the dry-erase marker is being pulled loose from receiver 124 (at least embodying herein wherein such at least one suction cup further comprises at least one suction cup stabilizer adapted to assist stabilizing of such at least one suction cup when such decorative support is pulled in at least one direction substantially parallel to the at least one non-porous essentially vertical surface; and, at least embodying herein wherein such suction means further comprises suction stabilizer means for assisting stabilizing of such suction means when such decorative support means is pulled in at least one direction substantially parallel to the at least one non-porous essentially vertical surface.)

Preferably, suction cup 112 is attached to decorative support base 102. Most preferably, suction cup 112 is attached to decorative support base 102 by mechanical attachment, preferably using a single screw 144, preferably centered in the support base 146 of the forward side 130 and threadably inserted through mounting projection 136 and into rear portion 148 of decorative support base 102, as shown (this arrangement at least embodies herein wherein such at least one suction cup is mechanically attached to such at least one decorative support). Upon reading the teachings of this specification, those with ordinary skill in the art will now understand that, under appropriate circumstances, considering such issues as economic consideration, user preference, decorative support base material, etc., other fastening methods to attach the suction cup 112 to the decorative support base 102, such as adhesive attachment, for example, by placing adhesive between the decorative support base 102 and the mounting projection 136 (at least embodying herein wherein such at least one suction cup is adhesively attached to such at least one decorative support), twist and lock attachment, integral manufacturing, molding, etc., may suffice.

Preferably, screw 144 is countersunk into support base 146 so that screw 144 is flush with face 150 of support base 146, as shown. Preferably, a small amount of sealant 152 is placed adjacent screw 144 between face 150 of support base 146 and end 138 of mounting projection 136 to seal screw aperture 154 so that the suction of suction cup 112 will not be lost by air leaking between decorative support base 102 and support base 146 through screw aperture 154. Upon reading the teachings of this specification, those with ordinary skill in the art will now understand that, under appropriate circumstances, considering such issues as user preference, mechanical attachment, decorative support base material, etc., other methods of forming a seal between the face of the support base and the end of the mounting projection, such as self-sealing screws, gaskets, pliant decorative support base material, etc., may suffice.

Preferably, decorative support base 102 may be changed to resemble one or more of a multitude of themed support base elements such as shown and described herein. This arrangement at least embodies herein wherein such at least one decorative support comprises at least one decorative theme element to provide a decorative theme to such at least one decorative base. The decorative support base changes in shape, dimension, and/or configuration, however the basic parts and functions as described above remain similar. Some additional embodiments of support base 100 and decorative support base 102 are now illustrated and described.

FIG. 5 shows a front view of another sport ball themed embodiment of the dry-erase marker support system. FIG. 5 illustrates a decorative support base 102 that resembles a soccer ball 160. Preferably, soccer ball 160 further comprises indicia 162, preferably including advertising indicia, corporate identifying indicia, product identifying indicia, etc. FIG. 6 shows a front view of another sport ball themed embodiment of the dry-erase marker support system. FIG. 6 illustrates a decorative support base 102 that resembles a football 164, preferably comprising indicia 166, preferably including advertising indicia, corporate identifying indicia, product identifying indicia, etc., as described herein.

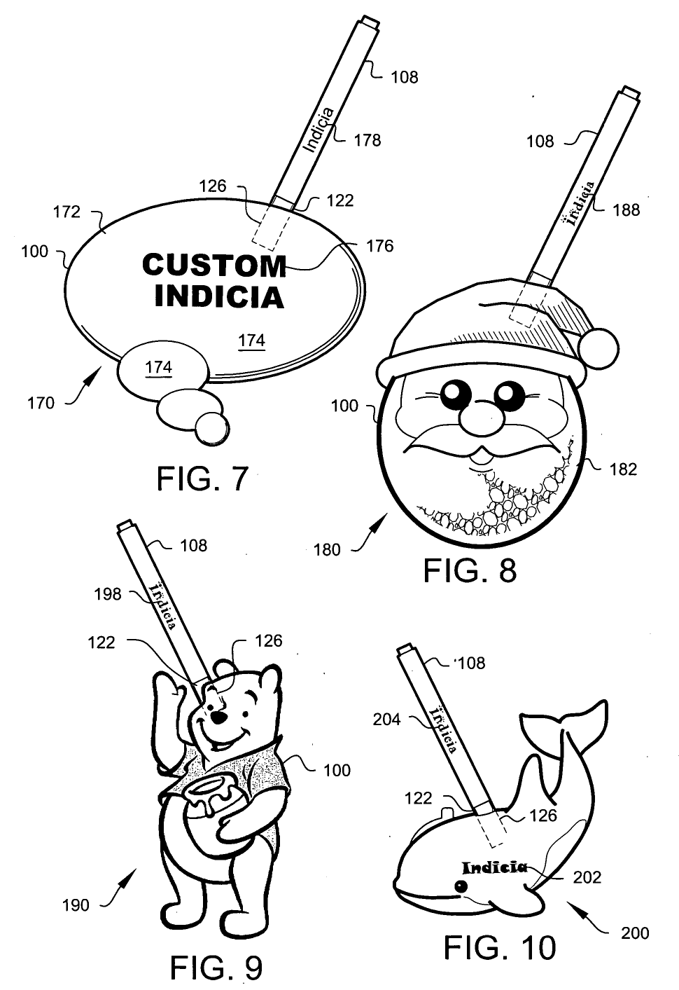

FIG. 7 shows a front view of a custom-printable-indicia-themed embodiment of the dry-erase marker support system according to a preferred embodiment of the present invention. Preferably, support base 100 comprises a custom indicia embodiment 170, as shown. Preferably, custom indicia embodiment 170 comprises a support base 100 having at least one flat face portion 172, preferably opposite the suction cup side, preferably having at least one printable surface 174 for applying, by printing, a custom user desired indicia 176, as shown. Additionally, the flat face portion 172 may be utilized to apply a custom printed label, etc. Upon reading the teachings of this specification, those with ordinary skill in the art will now understand that, under appropriate circumstances, considering such issues as economic considerations, user preferences, printing techniques, surface materials, etc., other methods of applying indicia, such as painting, integral molding, adhesive, mechanical attachment, etc., may suffice. Furthermore, the dry-erase marker preferably comprises indicia 178, preferably selected from indicia identifying the manufacturer, supplier or seller of the dry-erase marker support system. Upon reading the teachings of this specification, those with ordinary skill in the art will now understand that, under appropriate circumstances, considering such issues as economic considerations, user preferences, etc., other types of indicia, such as advertising indicia, instructional indicia, etc., may suffice.

FIG. 8 shows a front view of a holiday themed embodiment 180 of the dry-erase marker support system according to a preferred embodiment of the present invention. Preferably, support base 100 may comprise a holiday themed decorative support base 182. For example, holiday themed decorative support base 182 may comprises holiday themes such as Christmas, Easter, Thanksgiving, Independence day, Ramadan, Passover, Rama-Lilas, Chinese New Year, etc. Upon reading the teachings of this specification, those with ordinary skill in the art will now understand that, under appropriate circumstances, considering such issues as culture, religion, season, user preference, etc., other holiday themed embodiments, such as birthdays, seasons, anniversaries, retirement, etc., may suffice. As stated above, the dry-erase marker 108 preferably comprises indicia 188, preferably selected from indicia identifying the manufacturer, supplier or seller of the dry-erase marker support system.

FIG. 9 shows a front view of a “licensable” themed embodiment 190 of the dry-erase marker support system according to a preferred embodiment of the present invention. Preferably, the decorative support base 102 comprises a “licensable” themed embodiment 190, as shown. Preferably, “licensable” themed embodiment 190 comprises a support base 100 resembling a figurine or character from a licensable entity, for example, a cartoon character, as shown. As stated above, the dry-erase marker 108 preferably comprises indicia 198, preferably selected from indicia identifying the manufacturer, supplier or seller of the dry-erase marker support system. Upon reading the teachings of this specification, those with ordinary skill in the art will now understand that, under appropriate circumstances, considering such issues as economic consideration, user preference, etc., other indicia, such as referencing the licensed character or theme as described above, etc., may suffice.

FIG. 10 shows a front view of a souvenir themed embodiment 200 of the dry-erase marker support system according to a preferred embodiment of the present invention. Preferably, such souvenir themes include souvenirs from establishments such as bars, museums, zoo's, theaters, restaurants, etc. Upon reading the teachings of this specification, those with ordinary skill in the art will now understand that, under appropriate circumstances, considering such issues as culture, religion, season, user preference, etc., other souvenir embodiments, such as picture frames, clocks, awards, gifts, certificate holders, special honors, etc., may also be supplied. Preferably, the souvenir themed embodiment 200 comprises other indicia 202, preferably identifying the souvenir establishment. As stated above, the dry-erase marker 108 preferably comprises indicia 204, preferably selected from indicia identifying the manufacturer, supplier or seller of the dry-erase marker support system.

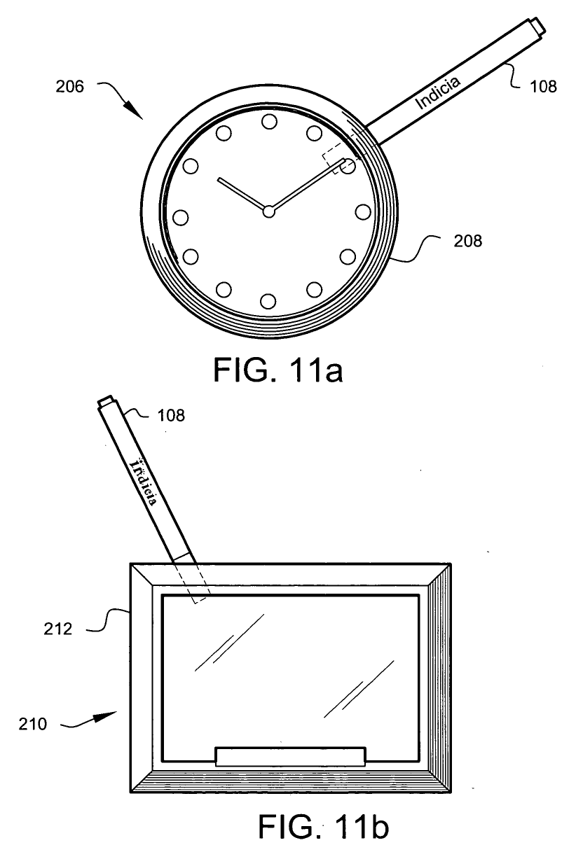

FIG. 11a shows a front view of a clock themed embodiment 206 of the dry-erase marker support system according to a preferred embodiment of the present invention. Preferably, the decorative support base 102 may be at least one clock 208, preferably operational, as shown. Although a standard clock is illustrated, upon reading the teachings of this specification, those with ordinary skill in the art will now understand that, under appropriate circumstances, considering such issues as economics, user preference, availability, country of origin, etc., other clock types, such as digital, sundial, battery operated, analog, etc., may suffice.

Upon reading the teachings of this specification, those with ordinary skill in the art will now understand that, under appropriate circumstances, considering such issues as user preference, cost, etc., other clocks, such as pseudo-clocks, etc., may suffice.

FIG. 11b shows a front view of a picture frame themed embodiment 210 of the dry-erase marker support system according to a preferred embodiment of the present invention. Preferably, the decorative support base 102 comprises at least one picture frame 212, as shown. Preferably, the picture frame 212 will hold at least one picture of the user's choice. Although a rectangular picture frame is illustrated, upon reading the teachings of this specification, those with ordinary skill in the art will now understand that, under appropriate circumstances, considering such issues as economics, user preference, availability, country of origin, etc., other picture frame types, such as round, square, trapezoidal, 3-Dimensional, etc., may suffice.

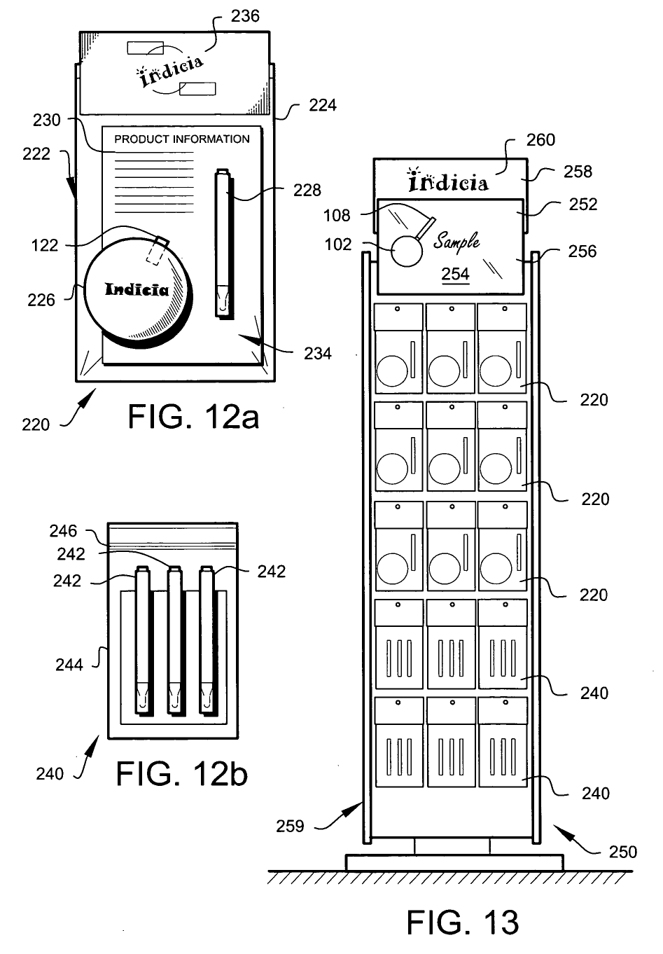

FIG. 12a shows a front perspective view of a kit system 220 of the dry-erase marker support system according to a preferred embodiment of the present invention. Preferably, the dry-erase marker support system comprises a kit system 220, preferably comprising a kit 222, preferably packaged in a container 224, as shown. Preferably, kit 222 comprises a decorative support base 226, preferably selected from one of the decorative bases described herein, a dry-erase marker 228, a set of instructions for use 230 (at least embodying herein wherein such at least one container comprises at least one set of instructions), and a container 224, as shown. The above arrangement at least embodies herein at least one first dry-erase marker adapted to mark dry-erasable indicia on at least one non-porous essentially vertical surface; at least one holder adapted to removably hold such at least one dry-erase marker; at least one decorative support adapted to decoratively support such at least one holder; at least one attacher adapted to removably and non-destructively attach such at least one decorative support to the at least one non-porous essentially vertical surface; and at least one first kit container adapted to contain such at least one dry-erase marker, such at least one holder and such at least one attacher.

Preferably, the decorative support base 226 comprises cap 122 adhered into the recessed bore 126 so that the dry-erase marker 108 may be removed from the cap 122 while the cap 122 is attached to the decorative support base 102, as described above and shown. Preferably, the dry-erase marker 228 comprises an additional cap 232 to preserve the dry-erase marker 228 while packaged and not installed into cap 122 in decorative support base 226, as shown. Preferably, decorative support base 226 further comprises suction cup 112 as described above. Upon reading the teachings of this specification, those with ordinary skill in the art will now understand that, under appropriate circumstances, considering such issues as economic considerations, user preference, preferred packaging etc., other kit arrangements, such as separating the holder or suction cup for user installation into the decorative support base, etc., may suffice.

Preferably, the container 224 comprises at least one translucent front portion 234 to assist easy viewing of the kit 222 contents, as shown (at least embodying herein wherein such at least one container comprises at least one transparent portion adapted to assist viewing of the dry-erase marker support kit system while contained by such at least one container). Preferably, the container 224 comprises indicia 236, preferably identifying the kit product, logo, service mark, etc.

FIG. 12b shows a front perspective view of an accessory kit system 240 of the dry-erase marker support system, comprising extra dry-erase markers 242, according to a preferred embodiment of the present invention. Preferably, at least one and, most preferably, three dry-erase markers 242 are placed into a preferably clear, preferably plastic, container 244, as shown (at least embodying herein further comprising at least one second kit container adapted to contain such at least one second dry-erase marker). Preferably, the container 244 has a “zippered” re-sealable opening 246, for example, similar to a Ziplock® brand seal, as shown. Upon reading the teachings of this specification, those with ordinary skill in the art will now understand that, under appropriate circumstances, considering such issues as economic consideration, user preference, manufacturing preference, dry-erase marker dimensions, etc., other sealable and re-sealable openings, such as heat-sealed, foldable, clipped, etc., may suffice.

FIG. 13 shows a front perspective view of a fixture display system 250 of the dry-erase marker support system according to a preferred embodiment of the present invention. Preferably, the dry-erase marker support system comprises a fixture display system 250 that displays a plurality of kit systems 220 for sale, as shown (at least embodying herein at least one display fixture structured and arranged to display a plurality of such at least one first kit containers; wherein such at least one display fixture comprises at least one mirror adapted to support at least one of such at least one decorative supports. Preferably, additional accessory kit systems 240 are also displayed, as shown (at least embodying herein wherein such at least one display fixture is structured and arranged to display a plurality of such at least one second kit containers). Preferably, the fixture display system 250 comprises at least one vertical surface 252, most preferably at least one mirror surface 254, to attach the suction cup 112, supporting the decorative support base 226 and dry-erase marker 108, as shown. This arrangement of a mirror 256 in combination with a display fixture 259 provides a preferable display for illustrating the dry-erase marker support system in preferred use. Additionally, the fixture display system 250 preferably comprises at least one sign 258 comprising indicia 260 to assist advertising and recognition of the dry-erase marker support system, as shown.

In operation, a user preferably removes the decorative base 226 and dry-erase marker 228 from the container 224. Preferably, the cap 232 is removed from the dry-erase marker 228 and the dry-erase marker 228 is placed into the cap 122 which is preferably permanently held in the recessed bore 126 as previously described above. Preferably, the decorative base 226, preferably comprising one of the themed decorative bases described herein, is then placed onto the user preferred non-porous essentially vertical surface, for example, a mirror 116. Preferably, the decorative base 226 is pressed so that the flexible vacuum producing elements 132 of the suction cup 112 are compressed and the suction cup 112 attaches to the mirror 116. Preferably, a user removes the dry-erase marker 228 from the cap 122 by pulling in at least one direction substantially parallel to the mirror 116 (non-porous essentially vertical surface) until the dry-erase marker 228 is uncoupled from the cap 122. Preferably, the dry-erase marker 228 is then used to write a message on the mirror 116 (or other non-porous essentially vertical surface such as ceramic tile, window, etc.). Preferably, when the user is finished with writing the message, the dry-erase marker 228 is then replaced into cap 122 by coupling the dry-erase marker into the cap 122.

Preferably, when the dry-erase marker 228 has been depleted, the user orders additional dry-erase markers 228 by contacting the supplier as described on indicia placed onto the decorative base 226 and/or dry-erase marker 228, preferably an Internet Universal Resource Locator web site address as described below,

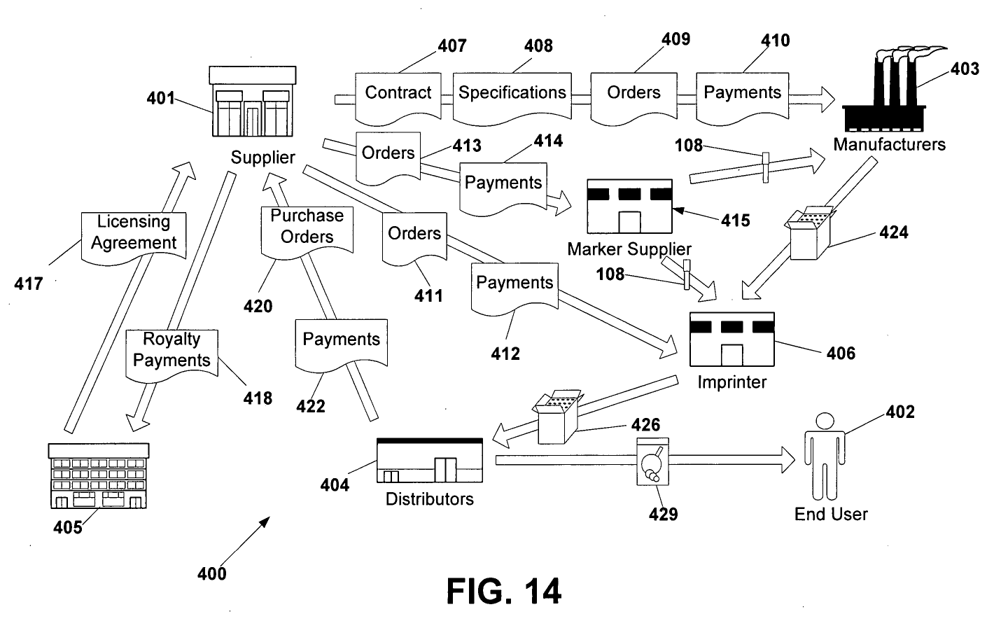

Referring to FIG. 14, which is a diagrammatic view of a system and method for selling at least one advertising marker system according to a preferred embodiment of the present invention, an overview of one preferred business method, production and distribution 400, where the marker system 429 is manufactured and delivered based on orders from distributors 404 such as retailers, souvenir providers and sports related entities is provided. Preferably, supplier 401 identifies manufacturers 403 capable of producing a decorative support base 102, and assembling the marker system 429, and separate imprinters 406 capable of printing indicia on the marker system 429. According to an alternate preferred embodiment, supplier 401 identifies manufacturers 403 capable of producing the decorative support base 102, assembling the marker system 429, and imprinting indicia onto the marker system 429. Additionally, preferably, supplier 401 identifies at least one marker supplier 415 to supply the required dry-erase marker 108 included with the decorative support base 102. Preferably the marker system 429 comprises at least one decorative support base 102 and at least one dry-erase marker 108 and at least one address (preferably an Internet universal resource locator address) for obtaining dry-erase marker 108 replacement, any required usage instructions and any required packaging.

Preferably, supplier 401 selects indicia to be applied to marker system 429. Preferably, supplier 401 contacts national and international indicia owners 405 and contracts for a licensing agreement 417 whereby indicia owner 405 agrees to allow supplier 401 to provide end users 402 with licensed marker system 429 displaying the indicia of indicia owner 405 or the decorative support base 102 representing, but not limited to, a specific sports item, cartoon character or souvenir item (embodying herein wherein such at least one decorative support comprises at least one sports-related representation; and, embodying herein further comprising the step of obtaining at least one license from at least one owner of such at least one sports-related representation; and embodying herein wherein such at least one marketing indicia comprises sports indicia; and, embodying herein further comprising the step of obtaining at least one license from at least one owner of such sports indicia; and, embodying herein further comprising the step of obtaining at least one license from at least one owner of such at least one cartoon-character-related representation; and, embodying herein further comprising the step of obtaining at least one license from at least one owner of such cartoon-character-related indicia; and embodying herein further comprising the step of obtaining at least one license from at least one owner of such at least one souvenir-related representation; and embodying herein further comprising the step of obtaining at least one license from at least one owner of such licensed souvenir indicia). Preferably, indicia comprise any marketing or advertising indicia. Upon reading the teachings of this specification, those with ordinary skill in the art will now understand that, under appropriate circumstances, considering issues such as market demand etc., other indicia arrangements may suffice, such as, for example, any type of indicia from anywhere in the world. Preferably, indicia comprise indicia involving sport governing associations, and/or manufacturers, and/or slogans, and/or advertisers, and/or racers, and/or players, and/or participants, and/or teams, and/or souvenirs including locations frequently visited by tourists, such as, but not limited to, U.S. national parks, amusement parks or similar attractions, and/or cartoon characters for example including, but not limited to, Winnie the Pooh, Spiderman, and the Hulk (embodying herein wherein such at least one owner of such sports indicia comprises at least one of the group consisting essentially of: a) sport governing associations; b) advertisers; c) manufacturers; d) teams; e) players; f) racers; and g) sport participants; and, embodying herein wherein such at least one decorative support comprises at least one cartoon-character-related representation; and, embodying herein wherein such at least one marketing indicia comprises cartoon-character-related indicia; and, embodying herein wherein such at least one decorative support comprises at least one souvenir-related representation; and embodying herein wherein such at least one souvenir indicia comprises licensed souvenir indicia).

Preferably, supplier 401 solicits orders from distributors 404 for marker system 429. Preferably, supplier 401 contacts distributors 404 and presents distributors 404 with a catalog of the various designs of the marker system 429. Distributors 404 that are related to sports are one group of business preferably solicited by supplier 401. Distributors 404 that are related to selling or distributing souvenirs are another group preferably solicited by supplier 401. Distributors 404 that are related to selling or distributing items based on cartoon characters are another group preferably solicited by supplier 401. Any business which wishes to advertise using promotional products imprinted with their logo and/or other indicia of the business are also preferably solicited by supplier 401. Supplier 401 then accepts a purchase order 420 for delivery of a specified number of the marker system 429 of the requested design, optionally imprinted with the agreed indicia, with desired delivery dates and delivery location from distributor 404 (embodying herein securing at least one order from at least one advertiser, having at least one marketing indicia, for such at least one marker system; and, embodying herein providing for delivery of such at least one marker system to at least one destination provided by such at least one advertiser; and embodying herein securing at least one order from at least one distributor for such at least one souvenir marker system; and embodying herein providing for delivery of such at least one souvenir marker system to at least one destination provided by such at least one distributor). Preferably, distributors 404 agree to make necessary payments 422 on satisfactory delivery of the ordered marker system 429 (embodying herein receiving from the at least one advertiser at least one payment for the at least one indicia-displaying marker system delivered to the at least one advertiser; and, embodying herein receiving from the at least one distributor at least one payment for the at least one indicia-displaying souvenir marker system delivered to the at least one advertiser).

Preferably, supplier 401 determines the preferred specifications 408 of each marker system 429 (preferably suited to the desires of distributors 404), such as decorative support base design, dimensions, color, materials, and location of indicia, if any) on the marker system 429, etc (embodying herein specifying at least one design for at least one marker system; and, embodying herein specifying at least one location, on such at least one marker system, for placement of such at least one marketing indicia; and, embodying herein specifying at least one design for at least one souvenir marker system; and, embodying herein specifying at least one location, on such at least one souvenir marker system, for placement of such at least one souvenir indicia). Preferably, marker system 429 comprises a wide variety of decorative support base designs intended to appeal to a wide variety of businesses including figures, shapes and household objects such as mirrors and clocks. Preferably, indicia are optionally placed on the decorative support base 102 of the marker system 429 and/or on the dry-erase marker 108 (embodying herein further comprising the step of placing such at least one marketing indicia on such at least one decorative support; and, embodying herein further comprising the step of placing such at least one marketing indicia on such at least one decorative support; and, embodying herein further comprising the step placing such at least one marketing indicia on such at least one dry-erase marker; and embodying herein further comprising the step of placing such at least one souvenir indicia on such at least one decorative support; and, embodying herein; and, embodying herein further comprising the step placing such at least one souvenir indicia on such at least one dry-erase marker). Upon reading the teachings of this specification, those with ordinary skill in the art will now understand that, under appropriate circumstances, considering issues such as market demand, advertiser request, etc., other indicia arrangements may suffice, such as, for example, placing indicia anywhere on the decorative support base 102, anywhere on the dry-erase marker 108, anywhere on any packaging, and/or anywhere on any package insert, etc.

Preferably, supplier 401 identifies and negotiates a contract 407 with at least one manufacturer 403 capable of producing the decorative support base 102 and assembling marker system 429. Preferably, at the conclusion of contract negotiations, supplier 401 provides manufacturer 403 specifications 408 and estimated production quantities and required delivery dates. Preferably, estimated delivery dates of the marker system 429 are provided to distributor 404 by supplier 401 who receives such information from manufacturer 403. Additionally, supplier 401 identifies and negotiates an order 413 with at least one marker supplier 415 capable of delivering the required number of dry-erase markers 108 on the required delivery date. Preferably the requested dry-erase markers 108 will be delivered to either manufacturer 403 or imprinter 406 as appropriate. The dry-erase markers 108 will be delivered to the manufacturer 403 if the manufacturer completes any required imprinting and assembly of the marker system 429.

Preferably supplier 401 places orders 409 for manufactured marker system 424, provides the specifications 408, and makes payments 410 for manufactured marker system 424 which are manufactured and delivered by manufacturer 403 according to contract 407 to the requested destination (embodying herein paying the at least one manufacturer for the shipped at least one indicia-displaying marker system; and, embodying herein paying the at least one manufacturer for the shipped at least one indicia-displaying souvenir marker system). Preferably, the manufactured marker system 424 is delivered to a selected imprinter 406, as shown if imprinting is required to be placed on the manufactured marker system 424. Alternatively, preferably, the manufactured marker system 424 is delivered directly to the appropriate distributor 404 when no imprinting is required. When distributors 404 have requested imprinting, supplier 401 identifies and negotiates an order 411 with at least one imprinter 406 capable of imprinting the desired indicia on the manufactured marker system 424. Preferably, orders 411 include delivery date, quantity, indicia sizes, locations, colors, and text. Preferably imprinting also includes the address of supplier 401 (preferably the web site Internet universal resource locator address) for replacement dry-erase marker 108 ordering (embodying herein further comprising the step of placing at least one supplier address, for ordering at least one dry-erase marker replacement kit, on such at least one decorative support; and, embodying herein wherein such at least one supplier address comprises at least one Internet universal resource locator address). Preferably imprinter 406 imprints the requested quantity of the manufactured marking system 424, assembles the components into a package and then ships the imprinted marking system 426 to distributors 404. Preferably supplier 401 then makes payments 412 to imprinter 406 for the quantity of imprinted marking system 426 delivered to distributors 404. According to an alternate preferred embodiment, manufacturer 403 produces the imprinted marking system 426 and ships to distributors 404. According to an alternate preferred embodiment, supplier 401 will manufacture the marker system 429 and deliver the manufactured marker system 424 to distributor 404 or to imprinter 406 for imprinting and delivery to distributor 404.

Preferably, imprinted marker system 426 is delivered to distributors 404. Preferably, distributors 404 supply marker system 429 to end users 402 as a promotional item either at no charge or for a nominal charge. Upon reading the teachings of this specification, those with ordinary skill in the art will now understand that, under appropriate circumstances, considering issues such as market demand, advertising strategy, etc., other distribution arrangements may suffice, such as, for example, selling marker system 429 etc.

Preferably, distributors 404 preferably remit payment to supplier 401 according to agreement 420. Preferably, supplier 401 preferably remits payments 410 to manufacturer 403 on confirmation of delivery to the requested destination, either imprinter 406 or distributor 404. Upon reading the teachings of this specification, persons of ordinary skill in the art will now understand that, under appropriate circumstances, considering issues such as cost, credit, marketing, distance, etc., alternate ordering methods, payment methods, sequences of steps, etc., may suffice. Upon reading the teachings of this specification, persons of ordinary skill in the art will now understand that, under appropriate circumstances, considering issues such as cost, convenience, efficiency, etc., alternate preferred forms of marketing distribution including, but not limited to, e-commerce through the Internet, television-based home shopping, catalog orders, mail orders, etc., may suffice.

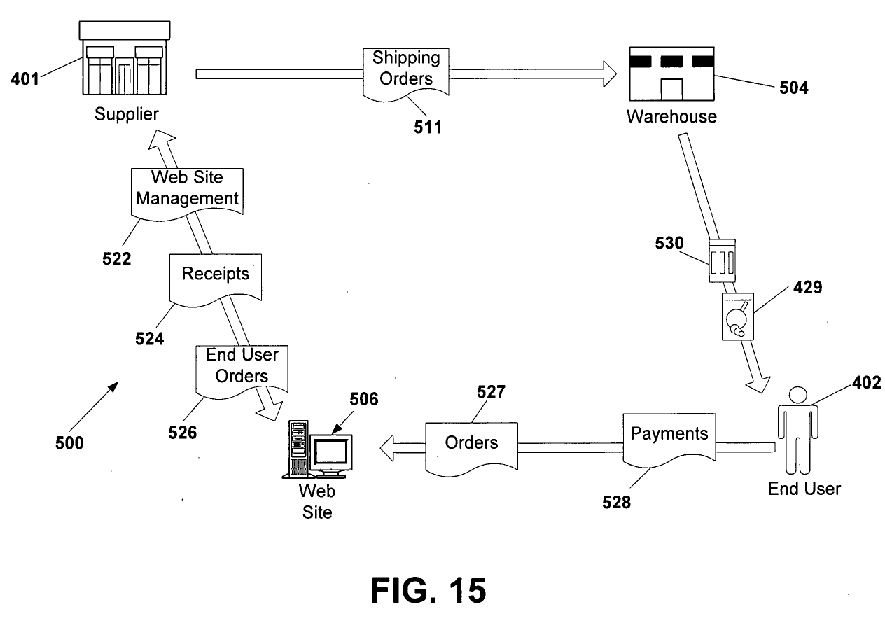

Referring to FIG. 15, which is a diagrammatic view of a system and method for Internet-based selling at least one marker system 429 according to a preferred embodiment of the present invention, the primary business tasks for the process Internet sales 500 are provided.

Preferably supplier 401 utilizes manufacturing, purchasing, imprinting and licensing arrangements described with reference to FIG. 14 which are omitted from FIG. 15 for clarity. Preferably supplier 401 will place orders with a marker supplier 415 for replacement dry-erase markers 108 preferably packaged three dry-erase markers 108 to a package (embodying herein specifying components of such least one dry-erase marker replacement kit; and, embodying herein wherein such components comprise at least one replacement dry-erase marker). Additionally, preferably supplier 401 will order the dry-erase markers 108 imprinted by marker supplier 415 with company name of supplier 401 (embodying herein placing at least one supplier indicia on each such at least one replacement dry-erase marker). According to an alternate preferred embodiment, supplier 401 will have company name of supplier 401 imprinted on the dry-erase markers 108 by an imprinter 406. Preferably supplier 401 establishes a web site 506 using appropriate methods of web site management 522 for offering a variety of designs of marker system 429 and replacement kits dry-erase marker 108 for sale directly to end users 402. Additionally, preferably the web site 506 will provide descriptions of various marker system 429 configurations and designs and ordering information to stimulate inquiries by distributors 404.

According to a preferred embodiment of the present invention, preferably end users 402 access the web site 506 identify the color and quantity of replacement dry-erase marker kit 530 desired and/or the design and quantity of additional marker system 429 desired, provide appropriate shipping information and preferably make payment 528 via the web site 506 using e-commerce methods (embodying herein permitting use of at least one Internet web site for creation of such at least one replacement order; and, embodying herein using such at least one Internet web site for receiving payment for such at least one replacement order). The receipts 524 and the end user orders 526 are then provided by the web site 506 to supplier 401 (embodying herein securing at least one replacement order from at least one end user for such at least one dry-erase marker replacement kit). Preferably supplier 401 then provides warehouse 504 the shipping orders 511 directing the warehouse 504 to ship the purchased replacement dry-erase marker kit 530 and/or marker system 429 to end users 402. Preferably, warehouse 504 is operated by supplier 401. According to an alternate preferred embodiment of the present invention, web site 506 may automatically send end user orders 526 directly to warehouse 504 for fulfillment of purchases by end users 402 (embodying herein providing for delivery of such at least one dry-erase marker replacement kit). According to a preferred embodiment of the present invention, warehouse 504 may be a fulfillment house operating independently of supplier 401 in which case payments are made to warehouse 504 in return for completing the fulfillment process.

Upon reading the teachings of this specification, persons of ordinary skill in the art will now understand that, under appropriate circumstances, considering issues such as cost, credit, marketing, distance, etc., alternate ordering methods, payment methods, sequences of steps, etc., may suffice. Upon reading the teachings of this specification, persons of ordinary skill in the art will now understand that, under appropriate circumstances, considering issues such as cost, convenience, efficiency, etc., alternate preferred forms of marketing and distribution including, but not limited to, television-based home shopping, catalog orders, mail orders, etc., may suffice.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

1. A dry-erase marker support system, comprising:
a) dry-erase marker means for marking dry-erasable indicia on at least one non-porous essentially vertical surface;
b) holder means for removably holding said dry-erase marker means;
c) decorative support means for decoratively supporting said holder means; and
d) attacher means for removably and non-destructively attaching said decorative support means to the at least one non-porous essentially vertical surface.

2. The dry-erase marker support system according to claim 1 wherein said attacher means comprises suction means for assisting suction attachment of said decorative support means to the at least one essentially non-porous vertical surface.

3. The dry-erase marker support system according to claim 2 wherein said suction means further comprises suction stabilizer means for assisting stabilizing of said suction means when said decorative support means is pulled in at least one direction substantially parallel to the at least one non-porous essentially vertical surface.

4. A dry-erase marker support system, comprising:
a) at least one dry-erase marker adapted to mark dry-erasable indicia on at least one non-porous essentially vertical surface;
b) at least one holder adapted to removably hold said at least one dry-erase marker;
c) at least one decorative support adapted to decoratively support said at least one holder; and
d) at least one attacher adapted to removably and non-destructively attach said at least one decorative support to the at least one non-porous essentially vertical surface.

5. The dry-erase marker support system according to claim 4 wherein said at least one attacher comprises at least one suction cup to assist suction attachment of said at least one decorative support to the at least one non-porous essentially vertical surface.

6. The dry-erase marker support system according to claim 5 wherein said at least one suction cup further comprises at least one suction cup stabilizer adapted to assist stabilizing of said at least one suction cup when said decorative support is pulled in at least one direction substantially parallel to the at least one non-porous essentially vertical surface.

7. The dry-erase marker support system according to claim 4 wherein said at least one holder further comprises at least one receiver structured and arranged to receive said at least one dry-erase marker.

8. The dry-erase marker support system according to claim 4 wherein said at least one dry-erase marker comprises:
a) at least one cap, having at least one exterior cap portion and at least one interior cap portion;
b) wherein said at least one interior cap portion is adapted to cap said at least one dry-erase marker; and
c) wherein said at least one exterior cap portion is removably coupled to said at least one dry-erase marker.

9. The dry-erase marker support system according to claim 8 wherein said at least one holder further comprises at least one receiver structured and arranged to receive said at least one exterior cap portion.

10. The dry-erase marker support system according to claim 9 wherein said at least one receiver comprises at least one recess in said at least one decorative support structured and arranged to receive the at least one exterior cap portion.

11. The dry-erase marker support system according to claim 10 wherein said at least one exterior cap portion of said at least one cap is permanently held in said at least one receiver.

12. The dry-erase marker support system according to claim 6 wherein said at least one suction cup comprises:
a) at least one forward side and at least one rearward side, adapted to removably attach to at least one non-porous essentially vertical surface;
b) wherein said at least one forward side comprises at least one flexible vacuum producer; and
c) wherein said at least one rearward side comprises at least one projection.

13. The dry-erase marker support system according to claim 12 wherein:
a) said at least one projection comprises at least one collar supporting at least one portion of the periphery of the projection;
b) wherein said at least one collar comprises said at least one suction cup stabilizer.

14. The dry-erase marker support system according to claim 12 wherein:
a) said at least one receiver comprises at least one recess in said at least one decorative support structured and arranged to receive said at least one projection; and
b) said at least one projection, when coupled within said at least one recess comprises said at least one suction cup stabilizer.

15. The dry-erase marker support system according to claim 5 wherein said at least one suction cup is mechanically attached to said at least one decorative support.

16. The dry-erase marker support system according to claim 5 wherein said at least one suction cup is adhesively attached to said at least one decorative support.

17. The dry-erase marker support system according to claim 4 wherein said at least one decorative support comprises at least one decorative theme element to provide a decorative theme to said at least one decorative support.

18. The dry-erase marker support system according to claim 17 wherein said at least one decorative theme element comprises at least one sport theme.

19. The dry-erase marker support system according to claim 17 wherein said at least one decorative theme element comprises at least one Holiday theme.

20. The dry-erase marker support system according to claim 17 wherein said at least one decorative theme element comprises at least one souvenir theme.

21. The dry-erase marker support system according to claim 17 wherein said at least one decorative theme element comprises at least one cartoon theme.

22. The dry-erase marker support system according to claim 17 wherein said at least one decorative theme element comprises at least one clock theme.

23. The dry-erase marker support system according to claim 17 wherein said at least one decorative theme element comprises at least one picture frame theme.

24. The dry-erase marker support system according to claim 17 wherein said at least one decorative theme element comprises at least one custom indicia theme.

25. The dry-erase marker support system according to claim 4 wherein said at least one dry-erase marker is adapted to write on at least one mirror surface.

26. The dry-erase marker support system according to claim 4 wherein said at least one decorative support base comprises at least one first indicia.

27. The dry-erase marker support system according to claim 4 wherein said at least one dry-erase marker comprises at least one second indicia.

28. A dry-erase marker decorative support system, comprising:
a) at least one dry-erase marker adapted to mark dry-erasable indicia on at least one non-porous essentially vertical surface;
b) at least one holder adapted to removably hold said at least one dry-erase marker;
c) at least one decorative support adapted to decoratively support said at least one holder; and
d) at least one attacher adapted to removably and non-destructively attach said at least one decorative support to the at least one non-porous essentially vertical surface;
e) wherein said at least one decorative support comprises at least one suction cup adapted to assist suction attachment of said at least one decorative support to the at least one non-porous essentially vertical surface;
f) wherein said at least one holder further comprises at least one receiver structured and arranged to receive at least one portion of said at least one suction cup;
g) wherein said at least one receiver comprises at least one recess in said at least one decorative support structured and arranged to recess the at least one portion of said at least one suction cup;
h) wherein the at least one portion of said at least one suction cup, when coupled within said at least one recess, assist stabilizing of said at least one suction cup to said at least one decorative support when said at least one decorative support is pulled in at least one direction substantially parallel to the at least one non-porous essentially vertical surface;
i) wherein said at least one dry-erase marker further comprises
i) at least one cap, having at least one exterior cap portion and at least one interior cap portion,
ii) wherein said at least one interior cap portion is adapted to cap said at least one dry-erase marker, and
iii) wherein said at least one exterior cap portion is removably coupled to said at least one dry-erase markerat least one cap, having at least one cap portion, adapted to cap said at least one dry-erase marker;
j) wherein said at least one cap is removably couplable to said at least one dry-erase marker;
k) wherein said at least one holder further comprises at least one receiver structured and arranged to receive said at least one exterior portion of said at least one cap;
l) wherein said at least one receiver comprises at least one recess in said at least one decorative support structured and arranged to recess said at least one exterior portion of said at least one cap;
m) wherein the at least one exterior portion of said at least one cap is permanently held in said at least one recess;
n) wherein said at least one dry-erase marker is removably coupled to said at least one cap;
o) wherein said at least one decorative support base may be removably attached to the at least one non-porous essentially vertical surface by said at least one suction cup; and
p) wherein said at least one dry-erase marker may be removed from said at least one interior cap portion to write on the at least one non-porous essentially vertical surface.

29. The dry-erase marker support system according to claim 28 wherein said at least one decorative support comprises at least one decorative theme element to provide a decorative theme to said at least one decorative support base.

30. The dry-erase marker support system according to claim 28 wherein said at least one dry-erase marker is adapted to write on at least one mirror surface.

31. A dry-erase marker support kit system, comprising:
a) at least one first dry-erase marker adapted to mark dry-erasable indicia on at least one non-porous essentially vertical surface;
b) at least one holder adapted to removably hold said at least one dry-erase marker;
c) at least one decorative support adapted to decoratively support said at least one holder;
d) at least one attacher adapted to removably and non-destructively attach said at least one decorative support to the at least one non-porous essentially vertical surface; and
e) at least one first kit container adapted to contain said at least one dry-erase marker, said at least one holder and said at least one attacher.

32. The dry-erase marker support kit system according to claim 31 wherein said at least one container comprises at least one set of instructions.

33. The dry-erase marker support kit system according to claim 32 wherein said at least one container comprises at least one transparent portion adapted to assist viewing of the dry-erase marker support kit system while contained by said at least one container.

34. The dry-erase marker support kit system according to claim 31 further comprising at least one second kit container adapted to contain said at least one second dry-erase marker.

35. The dry-erase marker support kit system according to claim 31 further comprising:
a) at least one display fixture structured and arranged to display a plurality of said at least one first kit containers;
b) wherein said at least one display fixture comprises at least one mirror adapted to support at least one of said at least one decorative supports.

36. The dry-erase marker support kit system according to claim 35 wherein said at least one display fixture is structured and arranged to display a plurality of said at least one second kit containers.

37. A method of marketing a plurality of marker systems, comprising, in combination, the steps of:
a) specifying at least one design for at least one marker system;
b) wherein such at least one marker system comprises
i) at least one dry-erase marker adapted to mark dry-erasable indicia on at least one non-porous essentially vertical surface,
ii) at least one holder adapted to removably hold said at least one dry-erase marker,
iii) at least one decorative support adapted to decoratively support said at least one holder, and
iv) at least one attacher adapted to removably and non-destructively attach said at least one decorative support to the at least one non-porous essentially vertical surface;
c) securing at least one order from at least one advertiser, having at least one marketing indicia, for such at least one marker system;
d) specifying at least one location, on such at least one marker system, for placement of such at least one marketing indicia;
e) providing for delivery of such at least one marker system to at least one destination provided by such at least one advertiser;
f) receiving from the at least one advertiser at least one payment for the at least one indicia-displaying marker system delivered to the at least one advertiser; and
g) paying the at least one manufacturer for the shipped at least one indicia-displaying marker system.

38. The method according to claim 37 further comprising the step of placing such at least one marketing indicia on such at least one decorative support.

39. The method according to claim 37 further comprising the step placing such at least one marketing indicia on such at least one dry-erase marker.

40. The method according to claim 38 further comprising the step of placing such at least one marketing indicia on such at least one dry-erase marker.

41. The method according to claim 38 further comprising the step of placing at least one supplier address, for ordering at least one dry-erase marker replacement kit, on such at least one decorative support.

42. The method according to claim 41 wherein such at least one supplier address comprises at least one Internet universal resource locator address.

43. The method according to claim 37 further comprising the steps of:
a) specifying components of such least one dry-erase marker replacement kit;
b) wherein such components comprise at least one replacement dry-erase marker;
c) placing at least one supplier indicia on each such at least one replacement dry-erase marker;
d) securing at least one replacement order from at least one end user for such at least one dry-erase marker replacement kit; and
e) providing for delivery of such at least one dry-erase marker replacement kit.

44. The method according to claim 43 wherein such step of securing at least one replacement order from at least one end user for such at least one dry-erase marker replacement kit comprises the steps of:
a) permitting use of at least one Internet web site for creation of such at least one replacement order; and
b) using such at least one Internet web site for receiving payment for such at least one replacement order.

45. The method according to claim 37 wherein such at least one decorative support comprises at least one sports-related representation.

46. The method according to claim 45 further comprising the step of obtaining at least one license from at least one owner of such at least one sports-related representation.

47. The method according to claim 38 wherein such at least one marketing indicia comprises sports indicia.

48. The method according to claim 47 further comprising the step of obtaining at least one license from at least one owner of such sports indicia.

49. The method according to claim 47 wherein such at least one owner of such sports indicia comprises at least one of the group consisting essentially of:
a) sport governing associations;
b) advertisers;
c) manufacturers;
d) teams;
e) players;
f) racers; and
g) sport participants.

50. The method according to claim 37 wherein such at least one decorative support comprises at least one cartoon-character-related representation.

51. The method according to claim 50 further comprising the step of obtaining at least one license from at least one owner of such at least one cartoon-character-related representation.

52. The method according to claim 37 wherein such at least one marketing indicia comprises cartoon-character-related indicia.

53. The method according to claim 52 further comprising the step of obtaining at least one license from at least one owner of such cartoon-character-related indicia.

54. A method of marketing a plurality of souvenir marker systems, comprising, in combination, the steps of:
a) specifying at least one design for at least one souvenir marker system;
b) wherein such at least one souvenir marker system comprises
i) at least one dry-erase marker adapted to mark dry-erasable indicia on at least one non-porous essentially vertical surface,
ii) at least one holder adapted to removably hold said at least one dry-erase marker,
iii) at least one decorative support adapted to decoratively support said at least one holder, and
iv) at least one attacher adapted to removably and non-destructively attach said at least one decorative support to the at least one non-porous essentially vertical surface;
c) securing at least one order from at least one distributor for such at least one souvenir marker system;
d) specifying at least one location, on such at least one souvenir marker system, for placement of at least one souvenir indicia;
e) providing for delivery of such at least one souvenir marker system to at least one destination provided by such at least one distributor;
f) receiving from the at least one distributor at least one payment for the at least one indicia-displaying souvenir marker system delivered to the at least one advertiser; and
g) paying the at least one manufacturer for the shipped at least one indicia-displaying souvenir marker system.

55. The method according to claim 54 further comprising the step of placing such at least one souvenir indicia on such at least one decorative support.

56. The method according to claim 54 further comprising the step placing such at least one souvenir indicia on such at least one dry-erase marker.

57. The method according to claim 55 further comprising the step of placing such at least one souvenir indicia on such at least one dry-erase marker.

58. The method according to claim 54 further comprising the step of placing at least one supplier address, relating to ordering at least one dry-erase marker replacement kit, on such at least one decorative support.

59. The method according to claim 58 wherein such at least one supplier address comprises at least one Internet universal resource locator address.

60. The method according to claim 54 further comprising the steps of:
a) specifying components of least one dry-erase marker replacement kit;
b) wherein such components comprise at least one replacement dry-erase marker;
c) placing at least one supplier indicia on each such at least one replacement dry-erase marker;
d) securing at least one replacement order from at least one end user for at least one dry-erase marker replacement kit; and
e) providing for delivery of at least one dry-erase marker replacement kit.

61. The method according to claim 60 wherein such step of securing at least one replacement order from at least one end user for such at least one dry-erase marker replacement kit comprises the steps of:
a) permitting use of at least one Internet web site for creation of such at least one replacement order; and
b) using such at least one Internet web site for receiving payment for such at least one replacement order.

62. The method according to claim 54 wherein such at least one decorative support comprises at least one souvenir-related representation.

63. The method according to claim 62 further comprising the step of obtaining at least one license from at least one owner of such at least one souvenir-related representation.

64. The method according to claim 54 wherein such at least one souvenir indicia comprises licensed souvenir indicia.

65. The method according to claim 64 further comprising the step of obtaining at least one license from at least one owner of such licensed souvenir indicia.
